(19) United States
(12) Patent Application Publication
(10) Pub. No.: US 2014/0164038 A1
(43) Pub. Date: Jun. 12, 2014

(54) Alignment of Territories for Marketing and Sales and a Method Thereof

(71) Applicant: Cozmix, Inc., Heathrow, FL (US)

(72) Inventor: Stephen Maughan, Longwood, FL (US)

(73) Assignee: Cozmix, Inc., Heathrow, FL (US)

(21) Appl. No.: 14/104,617

(22) Filed: Dec. 12, 2013

Related U.S. Application Data
(60) Provisional application No. 61/736,090, filed on Dec. 12, 2012.

(51) Int. Cl. G06Q 10/06

(52) U.S. Cl. CPC G06Q 10/06311
USPC 705/7.13

(57) ABSTRACT

A system allows a user to reassign and/or assign territories, geographical territories for marketing and sales purposes. The system displays a geographical area that have assignable, bounded areas. The user selects an area and, by moving a finger or cursor, may add additional areas to the selected area or territory. By also using a function key at the same time, the user can limit the areas added to the territory to other larger geographically defined areas.

### REFERENCE TO RELATED CASE

This application claims priority under 35 U.S.C. §119 (e) to provisional application No. 61/736,090, filed on Dec. 12, 2012, the contents of which are hereby incorporated by reference in their entirety.

### BACKGROUND OF THE INVENTION

1. Field of the Invention

The present invention relates to a system and a method of aligning or assigning territories for marketing and sales purposes. Typically, the process of assigning geographic areas to territories (for sales, service, franchising, etc.) is done in one of two ways. The first is by taking the geographic area that is to be moved and moving it into the destination territory—a drag and drop method of reassignment. However, this method allows the user to move only one area at a time. It is time consuming and tedious. The second method involves identifying the destination territory and then either clicking on or highlighting the appropriate geographic areas to add to the destination area. This method requires many clicks of the mouse.

Thus, the present invention allows for the reassignment or the assignment of geographical areas to a responsible person's territory with a single click of the mouse or pointer.

2. Summary of the Invention

The present invention is directed to a sales territory design system that includes at least one computer processor, a display coupled to the at least one computer processor, and a memory coupled to the at least one computer processor, the sales territory design system is configured for displaying on the display a geographic area, the geographic area comprising a plurality of predefined areas and the geographic area is also divisible into a plurality of sales territories, wherein each of the plurality of sales territories includes a plurality of the predefined areas, and also for adjusting a first sales territory in the plurality of sales territories to add at least one of the plurality of predefined areas in response to a user selecting the first sales territory with a pointer and then moving the pointer to another portion of the geographic area, whereby the predefined areas pointed to by the user outside the first sales territory are added to the first sales territory.

In some embodiments, the predefined areas correspond to areas selected from the group of postal codes, zip codes, telephone area codes, county boundaries, municipal boundaries, and congressional boundaries.

In some embodiments, the geographic area is further divided into a plurality of sub-geographic areas, each of the sub-geographic areas having at least two of the plurality of predefined areas.

In some embodiments, the sub-geographic area is chosen by the user when using a function key associated with the at least one computer processor and selecting the first sales territory with the pointer.

In some embodiments, when the user points to at least one predefined area that is not in one of the plurality of sales territories, a new sales territory is created with the selected at least one of the plurality of predefined areas.

In yet another aspect, the present invention is directed to a sales territory design system that includes at least one computer processor, a display coupled to the at least one computer processor, and a memory coupled to the at least one computer processor, the sales territory design system is configured for displaying on the display a geographic area, the geographic area comprising a plurality of predefined areas and the geographic area is also divisible into a plurality of sales territories, wherein each of the plurality of sales territories includes a plurality of the predefined areas, and for designing a first sales territory in the plurality of sales territories in response to a user selecting at least one of the plurality of predefined areas with a pointer and moving the pointer to at least one other of the plurality of predefined areas in another portion of the geographic area, whereby the predefined areas pointed to by the user outside the at least one plurality of predefined areas and the first sales territory are added to the first sales territory.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is schematic of a one embodiment of a system according to the present invention;

FIG. 2 is a flowchart showing the use of the system to assign territories;

FIG. 3 is a representation of a screen of the system illustrating the geographic area, territories, and predefined areas according to one embodiment of the present invention;

FIG. 4 is a representation of the geographic area of FIG. 3 illustrating the transition of predefined areas from one territory to the destination territory;

FIG. 5 is a representation of the geographic area of FIG. 3 illustrating the new territory after the selected predefined areas have been reassigned from one territory to the destination territory;

FIG. 6 is representation of a screen of the system illustrating the geographic area, territories, and predefined areas that are yet to be assigned to territories;

FIG. 7 is a representation of the geographic areas of FIG. 6 with the pointer selecting a first unassigned predefined area to assign it to a new territory according to one embodiment of the present invention;

FIG. 8 is a representation illustrating the newly created territory of FIG. 6 after additional selected predefined areas have been assigned to the new destination territory;

FIG. 9 is a representation of a screen of the system illustrating the geographic area, territories, and predefined areas according to one embodiment of the present invention;

FIG. 10 is a representation of the screen of FIG. 9 and the use of a function key with the pointer and the selecting predefined areas within a sub-geographic area.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

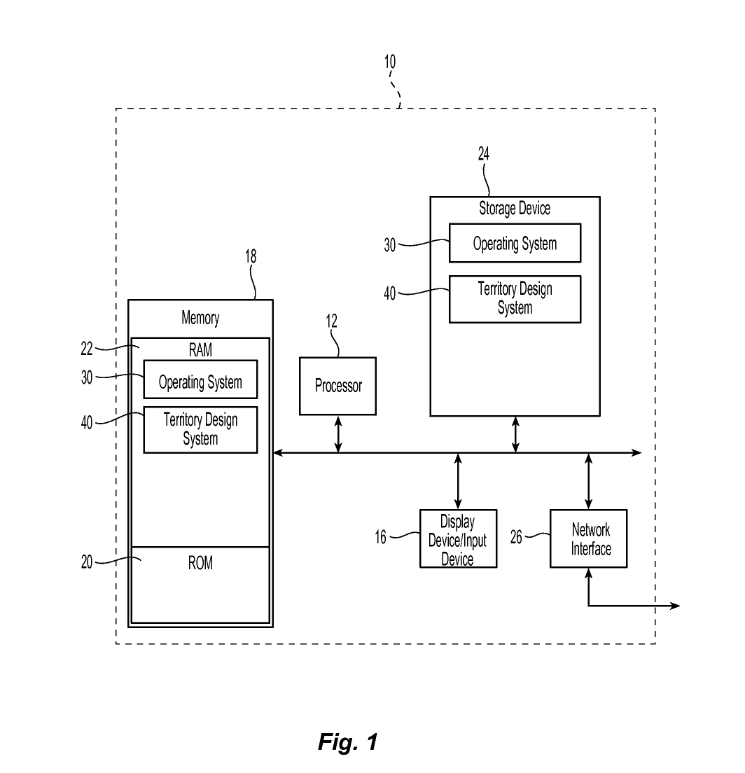

FIG. 1 is a schematic of one embodiment of a system 10 according to the present invention. As may be understood the system 10 includes a processor 12 that communicates with other elements within the system 10 via a system interface or bus system 14. Also included in the system 10 is a display device/input device 16 for receiving and displaying data. This display device/input device 16 may be, for example, a keyboard, a touch-sensitive screen, or a pointing device that is used in combination with a monitor. The system 10 further includes memory 18, which preferably includes both read only memory (ROM) 20 and random access memory (RAM) 22. The system's ROM 20 is used to store appropriate systems that help to transfer information between elements within the system 10.

In addition, the system 10 includes at least one storage device 24, such as a flash drive, a hard disk drive, a floppy disk drive, a CD Rom drive, or optical disk drive for storing information on various computer-readable media, such as a hard disk, a removable magnetic disk, or a CD-ROM disk. As will be appreciated by one of ordinary skill in the art, each of these storage devices 24 is connected to the system bus 14 by an appropriate interface. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 22. Such program modules include an operating system 30 and the territory design system 40, as well as possible geographic programs as well. As described in more detail below, the territory design system 40 controls certain aspects of the operation of the system 10 with the assistance of the processor 12 and an operating system 30.

Also located within the system 10 is a network interface 26, for interfacing and communicating with other elements of a computer network if so desired. It will be appreciated by one of ordinary skill in the art that one or more of the system 10 components may be located geographically remotely from other system 10 components. Furthermore, one or more of the components may be combined, and additional components performing functions described herein may be included in the system 10.

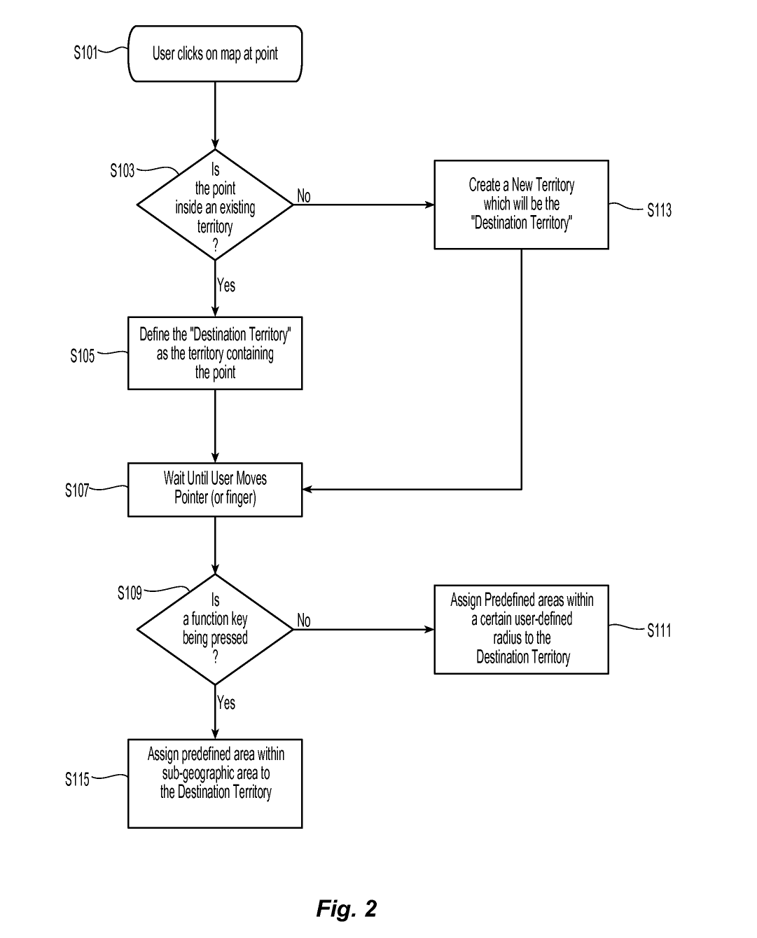

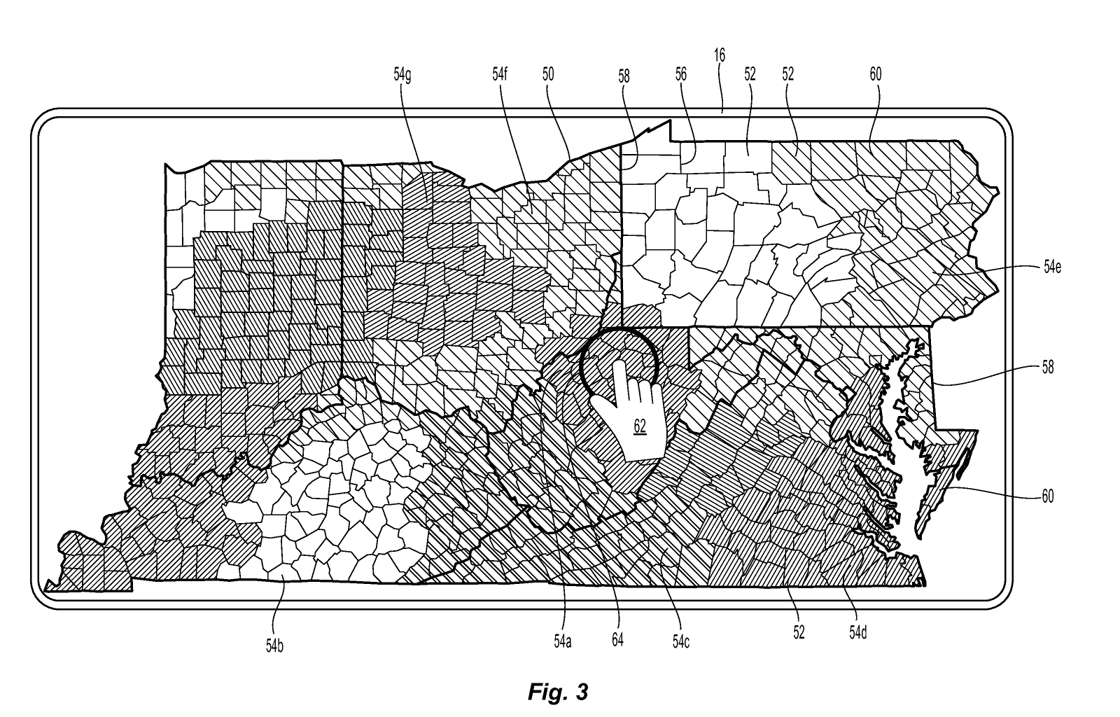

The operation of one embodiment of the system 10 is described in conjunction with the flowchart illustrated in FIG. 2 and the maps in FIGS. 3-5. The system 10 displays on a display, such as the device/input device 16, a geographic area 50. A representation of the geographic are 50 is illustrated in FIGS. 3-5. The geographic area 50 is used design territories for assignment to sales people, account managers, account representatives, franchise territories, service territories, or for any other purpose where geographic areas are divided up and assigned. Thus, the geographic area 50 may be any geographic area, including but not limited to states, countries, territories, continents, or portions thereof. The geographic area 50 is then divided up into smaller predefined areas 52. The predefined areas 52 can be defined by postal codes, zip codes, telephone area codes, county boundaries, municipal boundaries, and/or congressional boundaries. Territories 54 are in turn defined by the predefined areas 52 that are assigned according to one of the purposes noted above. The territories 54 are usually defined by more than one of the predefined areas 52, but the territories 54 may also be a single predefined area 52. Additionally, several of the predefined areas 52 illustrated in FIG. 3 may be combined to redefine one of the predefined areas 52. For example, several zip codes or area codes may be logically grouped together to create a predefined area 52 for the purposes of this invention.

The predefined areas 52 or geographic area 50 may also be divided into other sub-geographic territories or groupings. For example, the predefined areas 52 may be grouped to make sub-geographic entities such as states, counties, municipalities, boroughs, etc., which are smaller than the geographic area 50 but at least as large as one of the predefined areas 52. As illustrated in figures, the lighter lines 56 are used to define the predefined areas 52, while the darker lines 58 are used to identify the boundaries of a sub-geographic region 60, such as a state.

Referring back to FIG. 3, a geographic area 50 (or a portion of a geographic area) is illustrated in the display. The lighter lines 56 and the darker lines 58 are visible, with the lighter lines 56 defining zip codes in the embodiment illustrated, and the darker lines 58 defining states. Territories 54 (7 labeled territories 54a, 54b, 54c, 54d, 54e, 54f, 54g in the figures) are illustrated in FIGS. 3-5 by the hatching of the territories and the predefined areas 52 within those territories.

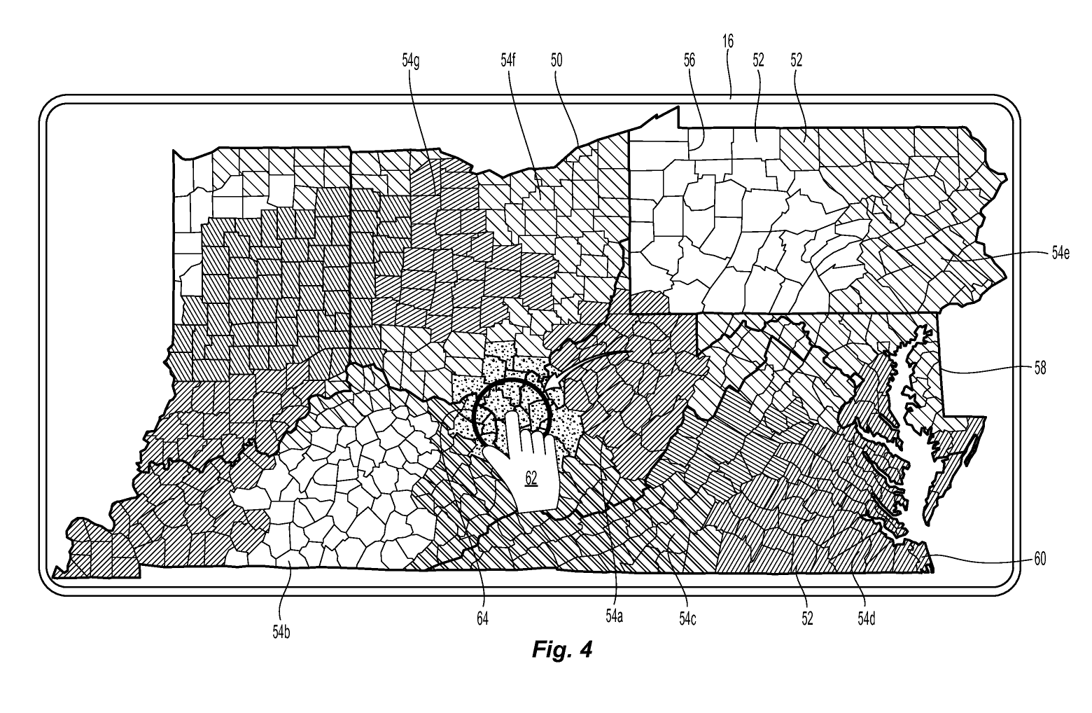

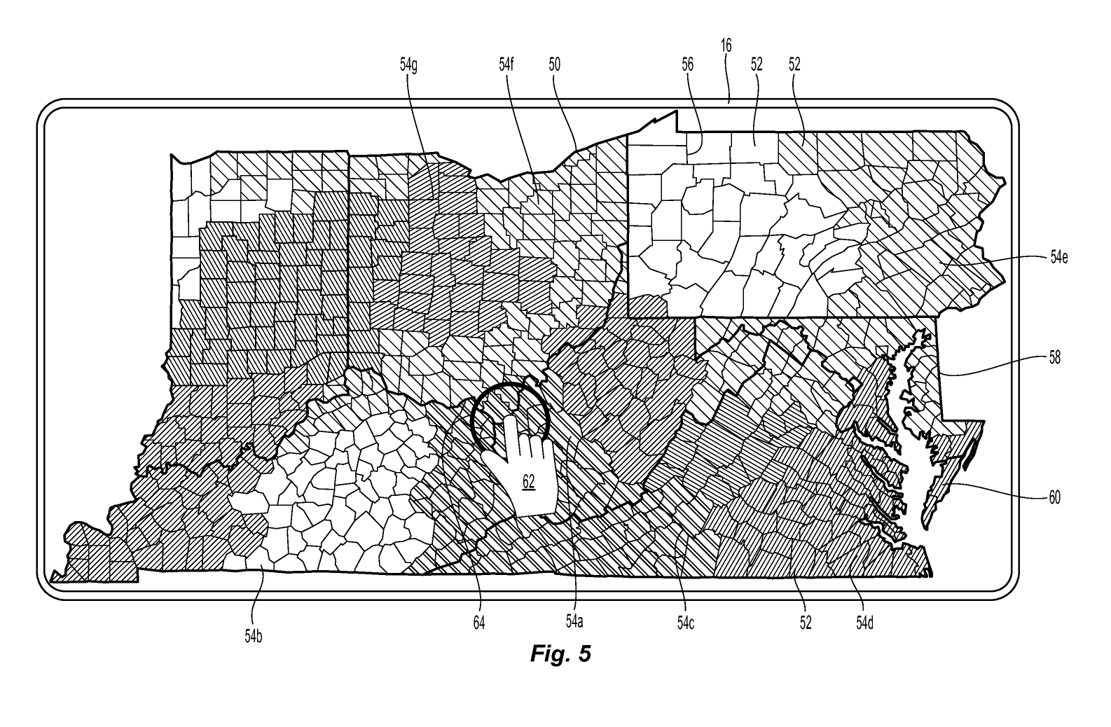

A pointer 62 is used to identify a territory 54 of interest, e.g. a destination territory 54a, and one that needs to have the boundaries of the territory changed. The pointer 62 is illustrated as a finger icon in FIGS. 3-5, could be any appropriate indicia, such as an arrow, a finger as illustrated or a personalized pointer, etc. According to step S101 in FIG. 2, the user moves the pointer 62 to the territory 54 of interest, such as destination territory 54a in FIG. 3. In this case, the answer to the question in step S103 is yes (the case of the pointer 62 being in an unassigned area is discussed in detail below) since the user is intentionally pointing to an assigned territory. At step S105, the system 10 identifies the territory as a destination territory. The user then left clicks on the mouse (if there is one), or if on a touch-screen device (i.e., a tablet, touch screen monitor, etc.) the user simply holds their finger, stylus, etc., on the screen and moves, as illustrated at step S107 and FIG. 4, the pointer 62 to the predefined areas 52 that are to be included in the destination territory 54a. These other predefined areas 52 may be predefined areas 52 in other territories (e.g., 541) or be predefined areas 52 that are not yet assigned to a territory 54. As illustrated in FIG. 4, the predefined areas 52 that were in territory 54e have a different identity (being stippled in FIG. 4) as the pointer 62 is moved over those areas and they are transitioning to territory 54a. In this example, a function key (the control key or some other assigned key in the system 10) is not being pressed at step S109. FIG. 5 illustrates the effect at step S111, where the system 10 assigns the predefined areas 52 to the territory 54a and those new territories have the same indicia as territory 54a and not territory 54f. The new territory 54a is automatically updated and stored in the memory 18. It should be noted that the territories are typically distinguished from one another with different colors, rather than with hatching or stippling as illustrated in the figures. However, system 10 can show the different territories in any appropriate fashion and still be within the scope of the present invention.

As noted in FIG. 2 at step S111 and as seen in FIGS. 3-5, the pointer 62 may also have a predetermined radius 64 around the pointer 62 and any predefined areas 52 that are at least partially within the radius 62 as the user moves the pointer 62 will be included in the new territory, such as territory 54a in the above example. The radius 64 may be adjustable, depending on the user's preference and the zoom factor on the geographic area 50.

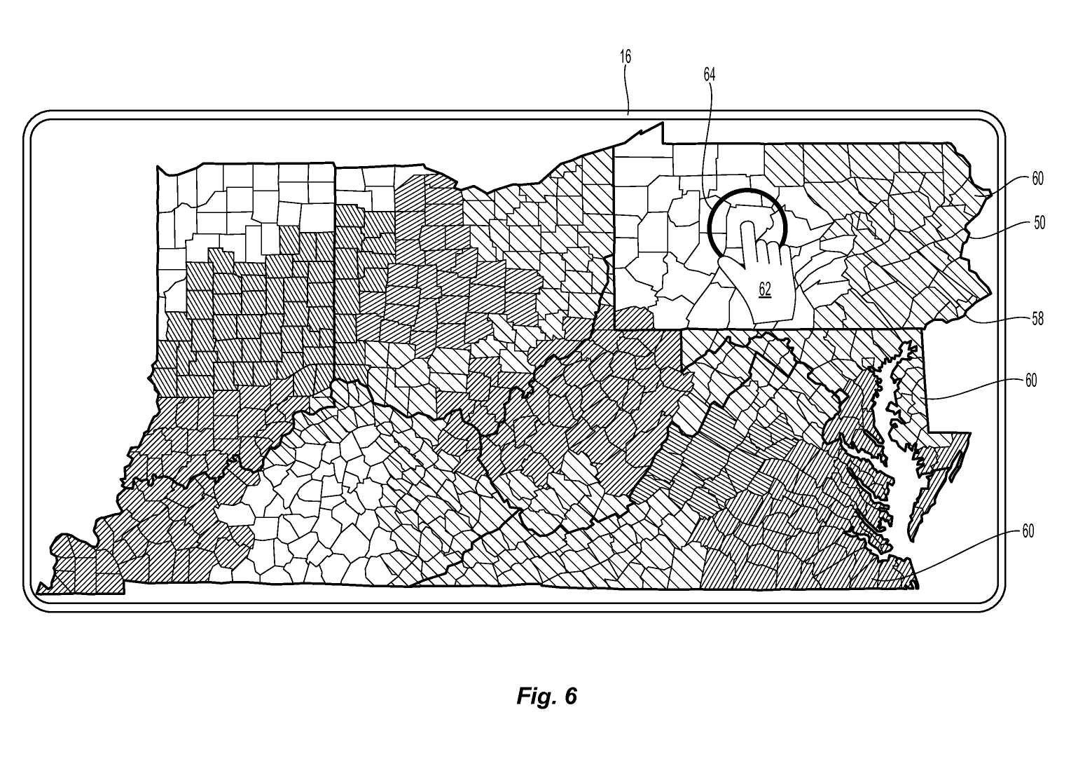

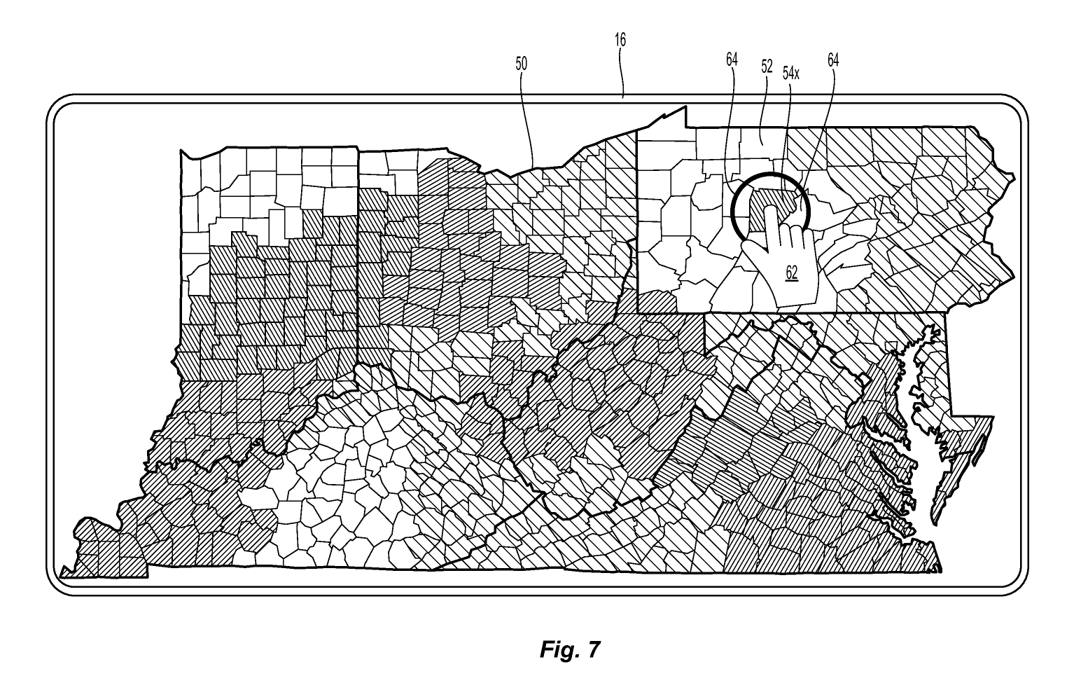

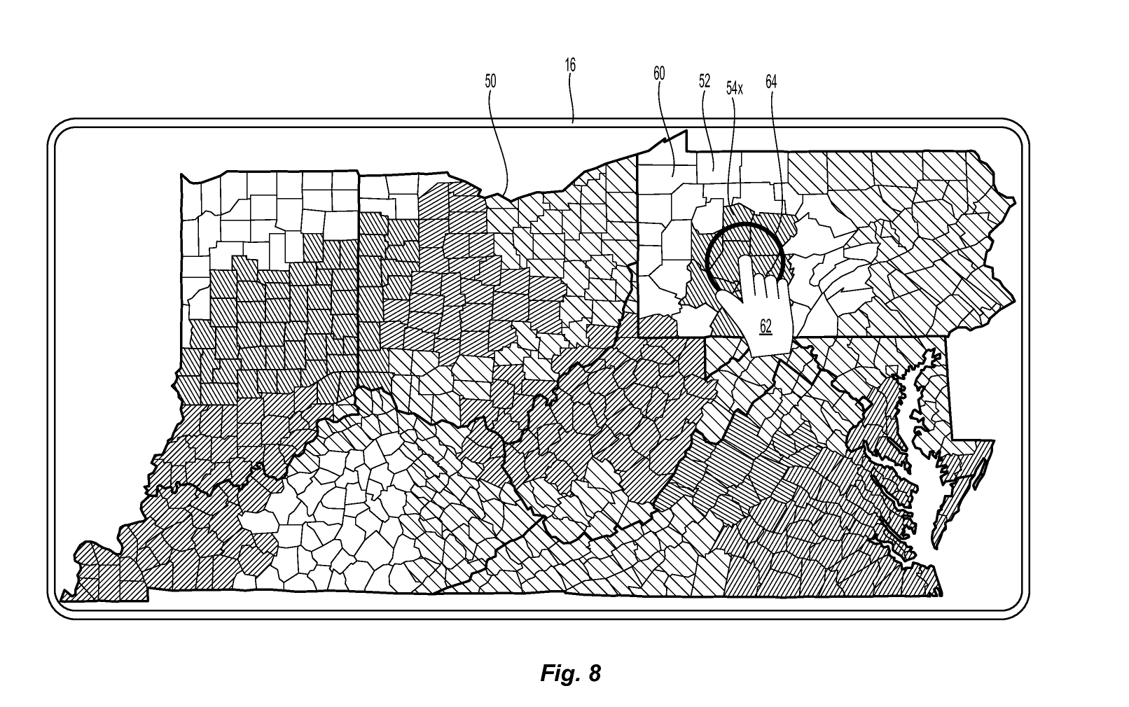

Turning now to FIGS. 6-8 and the flowchart in FIG. 2 at step S103. If the user points pointer 62 to a position on the geographic area 50 that has yet to be assigned, the predefined area or areas 52 covered by the pointer 62 and the radius 64 are assigned to a new territory 54x at step S113. See FIG. 7. The process returns to step S107, where the user moves the pointer 62 to other predefined areas 52 that are to be included in the new territory 54x as illustrated in FIG. 8. Again skipping over step 5109 for the moment, at step S111, the new predefined areas 52 are assigned to the new territory 54x and stored in the memory 18.

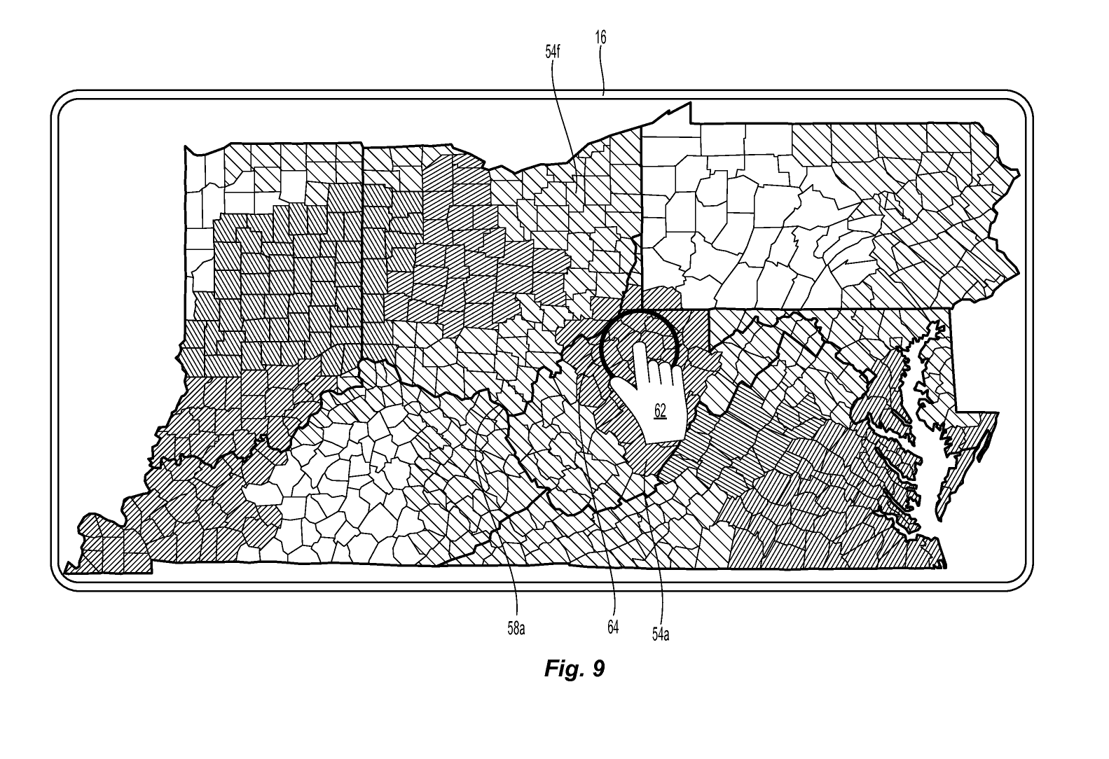

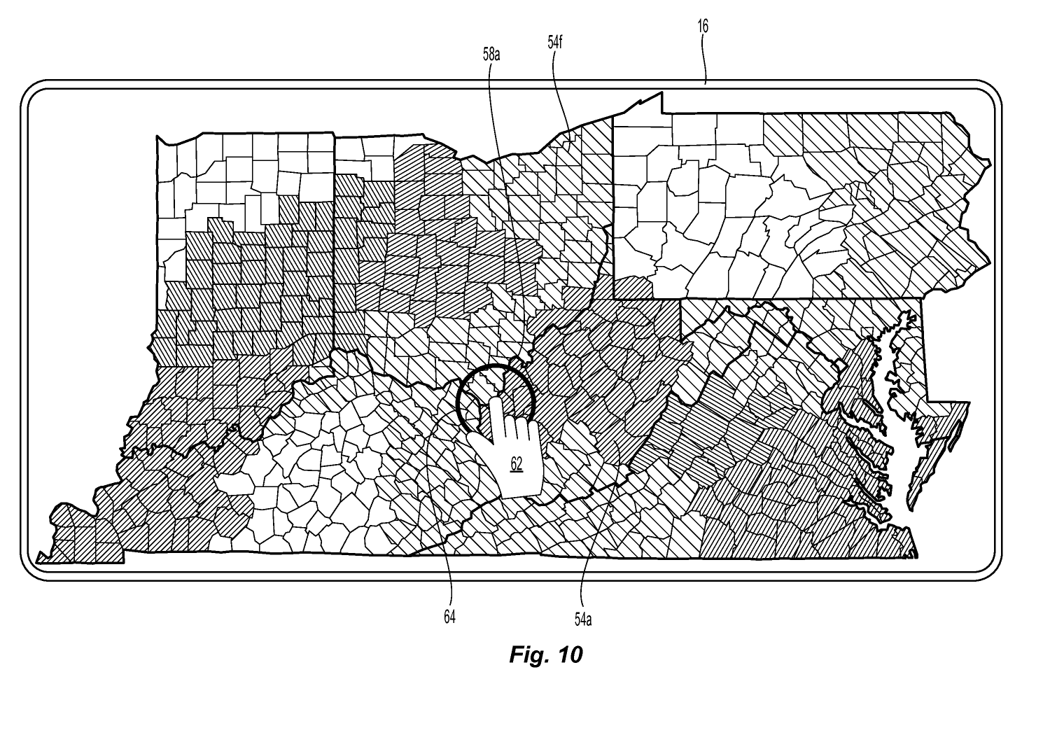

Returning to FIG. 2 and step S109, the user can press a function key on a computer keyboard, such as the control key or other appropriate function key, which then limits the predefined areas 52 that are assigned to the destination territory 54. On a tablet or other mobile device or a device with a touch screen, the function key may be a softkey that is displayed on the display 16 or the user may select a mode of operation prior to selecting the territory to activate this function. With reference to FIGS. 9 and 10, the use of the function key will be explained. If the function key is pressed (by way of the input device 16) or the mode is selected by the user when the pointer 62 is located in a territory (or even if the predefined areas 52 have not yet been assigned), the only predefined areas 52 within the boundaries of a sub-geographic region 60 in the which the user selected the territory can be added. As illustrated in FIG. 9, the user has selected the territory 54a. As the user moves the pointer 62 down and to the left in the figure, there is a boundary line 58a that the radius 64 of the pointer 62 has crossed. However, in comparing FIGS. 9 and 10, there are predefined areas 52 above the boundary line 58a and within the radius 64 that have not been assigned to territory 54a, but remain in territory 54f as a result of the function key or mode being used.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. A sales territory design system comprising:
at least one computer processor;
a display coupled to the at least one computer processor; and
a memory coupled to the at least one computer processor, the sales territory design system is configured for:
displaying on the display a geographic area, the geographic area comprising a plurality of predefined areas and the geographic area is also divisible into a plurality of sales territories, wherein each of the plurality of sales territories includes a plurality of the predefined areas; and
adjusting a first sales territory in the plurality of sales territories to add at least one of the plurality of predefined areas in response to a user selecting the first sales territory with a pointer and then moving the pointer to another portion of the geographic area, whereby the predefined areas pointed to by the user outside the first sales territory are added to the first sales territory.

2. The sales territory design system according to claim 1, wherein the predefined areas correspond to areas selected from the group of postal codes, zip codes, telephone area codes, county boundaries, municipal boundaries, and congressional boundaries.

3. The sales territory design system according to claim 1, wherein the geographic area is further divided into a plurality of sub-geographic areas, each of the sub-geographic areas having at least two of the plurality of predefined areas.

4. The sales territory design system according to claim 3, wherein the sub-geographic area is chosen by the user when using a function key associated with the at least one computer processor and selecting the first sales territory with the pointer.

5. The sales territory design system according to claim 1, wherein the display is a touch screen and the pointer is a finger.

6. The sales territory design system according to claim 1, wherein the pointer is a cursor.

7. The sales territory design system according to claim 1, wherein the system is further configured for saving information about the plurality of sales territories.

8. The sales territory design system according to claim 1, wherein the plurality of sales territories are displayed on the display in a predetermined color, each the plurality of sales territories being displayed as a different color and wherein the predefined areas change colors in response to being moved from one of the plurality of sales territories to another of the plurality of sales territories.

9. The sales territory design system according to claim 1, wherein when the user points to at least one predefined areas that is not in one of the plurality of sales territories, a new sales territory is created with the selected at least one of the plurality of predefined areas.

10. A sales territory design system comprising:
at least one computer processor;
a display coupled to the at least one computer processor; and
a memory coupled to the at least one computer processor, the sales territory design system is configured for:
displaying on the display a geographic area, the geographic area comprising a plurality of predefined areas and the geographic area is also divisible into a plurality of sales territories, wherein each of the plurality of sales territories includes a plurality of the predefined areas; and
designing a first sales territory in the plurality of sales territories in response to a user selecting at least one of the plurality of predefined areas with a pointer and moving the pointer to at least one other of the plurality of predefined areas in another portion of the geographic area, whereby the predefined areas pointed to by the user outside the at least one plurality of predefined areas and the first sales territory are added to the first sales territory.

11. The sales territory design system according to claim 10, wherein the predefined areas pointed to by the user are in another of the plurality of sales territories and are removed from the another of the plurality of sales territories upon pointing by the user.

12. A method of assigning sales territories comprising:
selecting at least one of a plurality of predefined areas with a pointer on a display coupled to at least one computer processor, the plurality of predefined areas being located in a geographic area and wherein the geographic area is also divisible into a plurality of sales territories and each of the plurality of sales territories includes a plurality of the predefined areas; and
moving the pointer within the geographic area to adjust a first sales territory in the plurality of sales territories to add at least one of the plurality of predefined areas, whereby the predefined areas pointed to by the user outside the first sales territory are added to the first sales territory.
